(19) United States
(12) Patent Application Publication
(10) Pub. No.: US 2009/0049519 A1
(43) Pub. Date: Feb. 19, 2009

(54) TERMINAL AND ACCESS POINT FINDING METHOD FOR COMMUNICATING WITH STEALTH ACCESS POINT

(75) Inventors: Shintaro Uno, Tokyo (JP); Tadayuki Fukuhara, Fujimino-shi (JP); Haruki Izumikawa, Fujimino-shi (JP)

Correspondence Address: MOTOROLA, INC., 1303 EAST ALGONQUIN ROAD, IL01/3RD, SCHAUMBURG, IL, 60196, US

(73) Assignees: MOTOROLA, INC., Schaumburg, IL (US); KDDI CORPORATION, Tokyo (JP)

(21) Appl. No.: 11/837,596

(22) Filed: Aug. 13, 2007

(51) Int. Cl. G06F 21/00

(52) U.S. Cl. 726/3

(57) ABSTRACT

There is provided a terminal that is capable of not sending a useless probe request to detect a stealth access point. The terminal communicates with a normal access point that reports a network identifier and a stealth access point that does not report a network identifier. The terminal includes an access point information accumulating section 103 for accumulating access point information that indicates whether each access point is a normal access point or a stealth access point, a beacon signal detecting section 101 for listening for and detecting a beacon signal, a probe request sending section 105 for sending a probe request, and an access point finding control section 102 for controlling the beacon signal detecting section 101 to detect the beacon signal with respect to the normal access point, and controlling the probe request sending section 105 to send the probe request with respect to the stealth access point.

### BACKGROUND OF THE INVENTION

1. Field of the Invention

The present invention relates to a terminal, a program, and an access point finding method for communicating with a stealth access point.

2. Description of the Related Art

There is a MAC (Medium Access Control) layer technology for controlling packet transmission between an access point and a terminal in wireless LAN. A MAC frame that is exchanged between radio stations by a MAC layer is defined by, for example, IEEE802.11 standard.

FIG. 1 is a system configuration diagram that shows a sequence of between a terminal and an access point in a conventional art.

In an infrastructure mode of IEEE 802.11, an access point sends a beacon signal containing an ESSID (Extended Service Set IDentifier) that is a network identifier to peripheral terminals at regular intervals (approximately every 100 ms). A terminal that receives the beacon signal can connect to the access point using the ESSID. In this way, the terminal can easily find an access point (a network identifier) around the terminal. In other words, this means that all terminals can find respective network identifies.

Recently, in view of security, the use of stealth access points has increased. “Stealth access point” refers to an access point that does not report a network identifier such as an ESSID. To prevent ESSID from being reported, there are a case where a beacon signal is stopped and a case where a beacon signal containing no ESSID is reported. By using a stealth access point, it is allowed that an existence of network cannot be easily detected by peripherals. A terminal has to know an ESSID of a stealth access point to connect to the stealth access point.

The terminal sends a probe request containing an ESSID of a stealth access point to find the stealth access point. When attempting to find all access points around the terminal, the terminal makes the probe request contain ESSID=any.

The stealth access point determines whether or not the ESSID contained in the received probe request matches with its own ESSID. If they match, the stealth access point sends a probe response containing the ESSID back to the terminal. However, if the probe request in which ESSID=any is received, the stealth access point does not send a probe response back to the terminal.

As a conventional art, there is a technology in which a terminal changes an access point connected thereto depending on application as necessary (see, for example, Wenhui Zhang, Jurgen Juhnert, Klaus Dolzer, “Design and Evaluation of A Handover Decision Strategy for 4th Generation Mobile Networks”, IEEE VTC, April 2003, Jeju, Korea). According to this technology, a certain base station broadcasts access point information according to the spot coverage of the station. A terminal that has received this access point information can determine an access point to be searched for depending on its current position.

In the conventional art, the terminal does not recognize whether such an access point is a normal access point or a stealth access point. Therefore, the terminal needs to listen for a beacon signal from an access point (a network identifier) as well as to report probe requests to all of pre-registered access points at regular intervals.

In the conventional art, the presence or absence of stealth of an access point is not set in a terminal. Therefore, even if the terminal exists in a position where it cannot communicate with the stealth access point, the terminal reports probe requests to all of pre-registered access points at regular intervals and also changes receive frequencies. Such operation leads not only to waste of radio resource but also to waste of power consumption of the terminal. When a large number of stealth access points are placed for security reasons in future, there is the need to find many stealth access points, and the number of transmission packets is increased.

Therefore, the present invention is intended to provide a terminal, a program, and an access point finding method that can prevent the terminal from sending a useless probe request to detect a stealth access point.

### SUMMARY OF THE INVENTION

According to the present invention, a terminal or device can communicate with a normal access point that reports a network identifier and a stealth access point that does not report a network identifier. The terminal includes access point information accumulating means for accumulating access point information that indicates whether each access point is a normal access point or a stealth access point. A beacon signal detecting means is included for listening for and detecting a beacon signal containing a network identifier. A probe request sending means is included for sending a probe request containing a network identifier. An access point finding control means is also included for controlling the beacon signal detecting means to detect the beacon signal with respect to the normal access point, and for controlling the probe request sending means to send the probe request with respect to the stealth access point.

According to another embodiment of the terminal of the present invention, the terminal may include a position measuring means for measuring a current position, wherein the access point information accumulating means contains spot coverage information in access point information of each access point, and wherein the access point finding control means controls the probe request sending means to send a probe request only to a stealth access point the spot coverage information of which includes the current position of the relevant terminal.

According to a further embodiment of the terminal of the present invention, the probe request sending means may preferably send a plurality of probe requests sequentially at a time interval that is shorter than a transmission interval of a normal probe request.

According to the present invention, a system that has the above-described terminal and a broadcast station that can send data to the terminal is characterized in that

the broadcast station broadcasts access point information that indicates whether each access point is a normal access point or a stealth access point; and

the terminal accumulates the received access point information in the access point information accumulating means.

According to the present invention, a program that causes a computer to function, the computer being provided in a terminal that can communicate with a normal access point that reports a network identifier and a stealth access point that does not report a network identifier, is characterized in that the program causes the computer to function as:

access point information accumulating means for accumulating access point information that indicates whether each access point is a normal access point or a stealth access point;

beacon signal detecting means for listening for and detecting a beacon signal containing a network identifier;

probe request sending means for sending a probe request containing a network identifier; and

access point finding control means for controlling the beacon signal detecting means to detect the beacon signal with respect to the normal access point, and controlling the probe request sending means to send the probe request with respect to the stealth access point.

According to another embodiment of the program for the terminal of the present invention, the program may preferably cause the computer to further function as:

position measuring means for measuring a current position,

wherein the access point information accumulating means contains spot coverage information in access point information of each access point, and

wherein the access point finding control means controls the probe request sending means to send a probe request only to a stealth access point the spot coverage information of which includes the current position of the relevant terminal.

According to a further embodiment of the program for the terminal of the present invention, the program may preferably cause the computer to function so that the probe request sending means sends a plurality of probe requests sequentially at a time interval that is shorter than a transmission interval of a normal probe request.

According to the present invention, an access point finding method in a terminal that can communicate with a normal access point that reports a network identifier and a stealth access point that does not report a network identifier, is characterized in that the method comprises:

an access point information accumulating section for accumulating access point information that indicates whether each access point is a normal access point or a stealth access point;

listening for and detecting a beacon signal containing a network identifier with respect to the normal access point; and

sending a probe request containing a network identifier with respect to the stealth access point.

According to another embodiment of the access point finding method of the present invention, it may be preferable that

the access point information accumulating section contains spot coverage information in access point information of each access point, and

the probe request sending comprises sending a probe request only to a stealth access point the spot coverage information of which includes the current position of the relevant terminal.

According to a further embodiment of the access point finding method of the present invention, the probe request sending may preferably comprise sending a plurality of probe requests sequentially at a time interval that is shorter than a transmission interval of a normal probe request.

According to a terminal, a program, and an access point finding method of the present invention, a probe request is not required to send to all of registered ESSIDs to find a stealth access point. Therefore, a terminal can reduce the number of transmissions of probe requests for finding a stealth access point, and radio resources of a network as well as power consumption of the terminal can be reduced.

### BRIEF DESCRIPTION OF THE DRAWINGS

FIG. 1 is a system configuration diagram that shows a sequence of between a terminal and an access point in the conventional art;

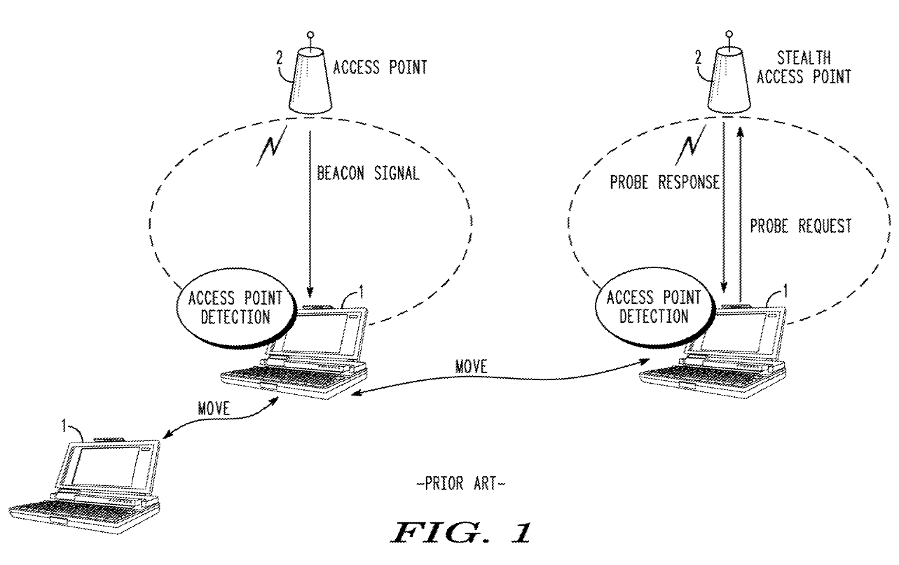

FIG. 2 is a system configuration diagram according to the present invention; and

FIG. 3 is a sequence diagram according to the present invention.

### DETAILED DESCRIPTION OF THE PREFERRED EMBODIMENTS

Hereinafter, preferred embodiments of the present invention will be described in detail with reference to the drawings.

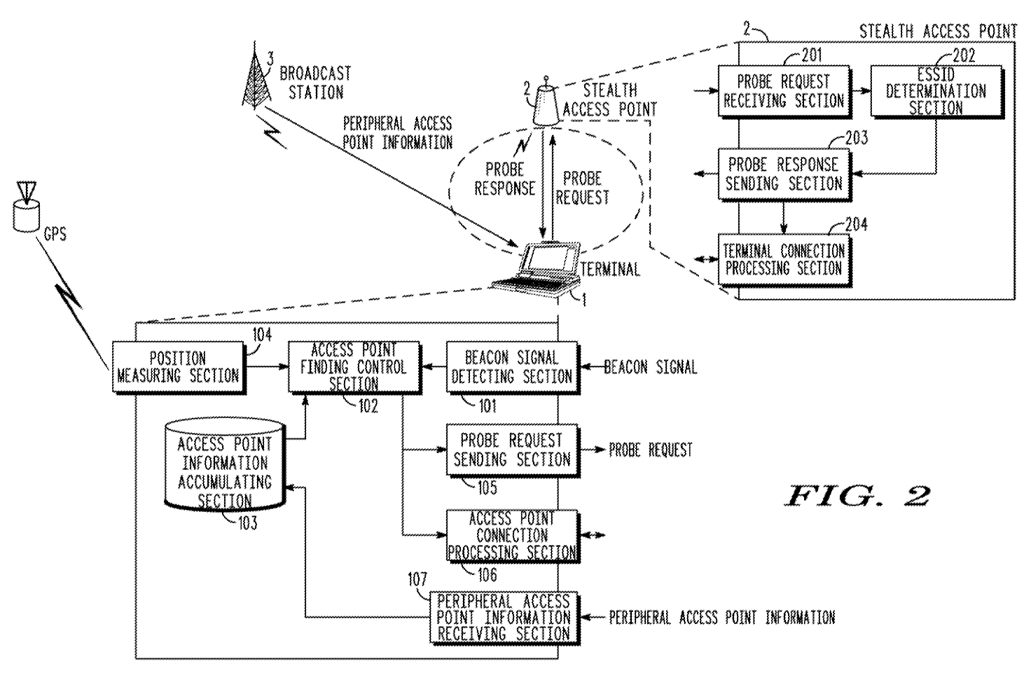

FIG. 2 is a system configuration diagram according to the present invention.

In FIG. 2, a terminal or device 1 is shown in a position or location where it can communicate with a stealth access point 2. In addition, the terminal 1 can receive peripheral access point information broadcasted from a broadcast station (or cellular base station) 3.

The terminal 1 includes a beacon signal detecting section 101, an access point finding control section 102, an access point information accumulating section 103, a position measuring section 104, a probe request sending section 105, an access point connection processing section 106, and a peripheral access point information receiving section 107. A program executed by a computer mounted in the terminal 1 may also implement these functional units.

The access point information accumulating section 103 accumulates access point information that indicates whether each access point is a normal access point or a stealth access point. The access point information accumulating section 103 accumulates a table, for example, as shown in the following table 1.

TABLE 1
Access point information

| | | | | | | |
|---|---|---|---|---|---|---|
| Network | Type | | | Presence | | Spot |
| identifier | of radio | Fre- | | or absence | Priority | coverage |
| ESSID | system | quency | WEP | of stealth | level | information |

ESSID refers to access point identifier, that is, “network identifier”. For each ESSID, “type of radio system”, “frequency”, and “WEP (Wired Equivalent Privacy)” are registered. According to the present invention, each ESSID further contains “presence or absence of stealth”, “priority level”, and “spot coverage information”.

The “presence or absence of stealth” indicates whether an access point of a relevant ESSID is a normal access point or a stealth access point. The “priority level” indicates an order of priority for access routers to which the terminal should connect, and ESSIDs are searched for in the order of descending priority levels. The “spot coverage information” indicates a spot coverage in which a terminal can communicate with an access point of a relevant ESSID. Spot coverage information is represented by, for example, the latitude and longitude of center point and the radius of a spot coverage.

The beacon signal detecting section 101 listens for and detects a beacon signal sent from a normal access point. When receiving a beacon signal, the beacon signal detecting section 101 notifies the access point finding control section 102 of the reception of the beacon signal.

A beacon signal is comprised of a MAC frame. The MAC frame is composed of “frame control”, “Duration ID”, “destination address”, “source address”, “BSSID (Basic Service Set IDentifier)”, “sequence control”, “frame body”, and “FCS”. A beacon signal is identified by “type” and “subtype” of the “frame control”. “Type=00” represents a management frame, and “subtype=1000” represents a beacon signal. The “BSSID” indicates a MAC address of an access point.

A message body of a beacon signal contains the following “beacon basic information”:

Timestamp: value of a timer TSFTIMER (in units of μs)

Beacon interval: beacon interval (in units of 1024 μs)

Capability Information: presence or absence of polling centralized control (PCF) or encryption

SSID (Service Set ID): ESSID or IBSSID

Supported Rate: a list of radio transmission rates supported by an access point

The probe request sending section 105 sends a probe request to the stealth access point 2. The probe request contains an ESSID to be found. The probe request sending section 105 may preferably send a plurality of probe requests sequentially at a time interval that is shorter than a transmission interval of a normal probe request. For example, probe requests are sent three times in sequence, and then a probe response is waited for in a certain period of time. If a probe response is not received, finding of the next access point is attempted without sending a further probe request. Thereby, time for finding a stealth access point can be reduced.

The access point finding control section 102 switches means for finding an access point based on the “presence or absence of stealth” of access point information accumulated in the access point information accumulating section 103. With respect to a normal access point, the beacon signal detecting section 101 detects a beacon signal. On the other hand, with respect to a stealth access point, the probe request sending section 105 is controlled to send a probe request. According to the present invention, the terminal sends a probe request only to a stealth access point and not to a normal access point. Such operation can reduce power consumption for the terminal to find an access point.

Then, the access point finding control section 102 controls the probe request sending section 105 to send a probe request only to a stealth access point the spot coverage information of which includes a current position of the relevant terminal. The current position of the relevant terminal is acquired from the position measuring section 104. Additionally, the spot coverage information of the stealth access point is acquired from the access point information accumulating section 103. Then, the access point finding control section 102 determines whether or not the current position of the relevant terminal exists within the spot coverage of the stealth access point. If it exists, the access point finding control section 102 instructs the probe request sending section 105 to send a probe request. Thus, the terminal 1 does not send a probe request to a stealth access point the spot coverage information of which does not include the current position of the terminal. Incidentally, the access point finding control section 102 searches for access points in the order of descending priority levels of access point information.

The position measuring section 104 measures a current position. For example, it acquires latitude/longitude information by a positioning function such as a GPS (Global Positioning System).

The access point connection processing section 106 processes a connection sequence with respect to an access point (a network identifier) found by the access point finding control section 102. When receiving a beacon signal or a probe response, the access point connection processing section 106 sends an association request to the access point 2 and processes the connection sequence.

The peripheral access point information receiving section 107 receives peripheral access point information from a broadcast station 3. The peripheral access point information is accumulated in the access point information accumulating section 103. Thereby, the terminal can recognize neighbor access points at its current position.

In FIG. 2, the stealth access point 2 includes a probe request receiving section 201, an ESSID determination section 202, a probe response sending section 203, and a terminal connection processing section 204.

The probe request receiving section 201 receives a probe request from the terminal 1. An ESSID contained in the received probe request is notified to the ESSID determination section 202.

The ESSID determination section 202 determines whether or not the ESSID received from the probe request receiving section 201 matches with an ESSID of the stealth access point itself. If they match, notification of this fact is given to the probe response sending section 203.

When the probe response sending section 203 is notified from the ESSID determination section 202 that the ESSIDs are identical, the probe response sending section 203 sends a probe response to the terminal 1. The probe response contains the same information elements as in the beacon signal.

The terminal connection processing section 204 processes a connection sequence with the terminal 1. The terminal connection processing section 204 receives an association request from the terminal 1 and processes the connection sequence.

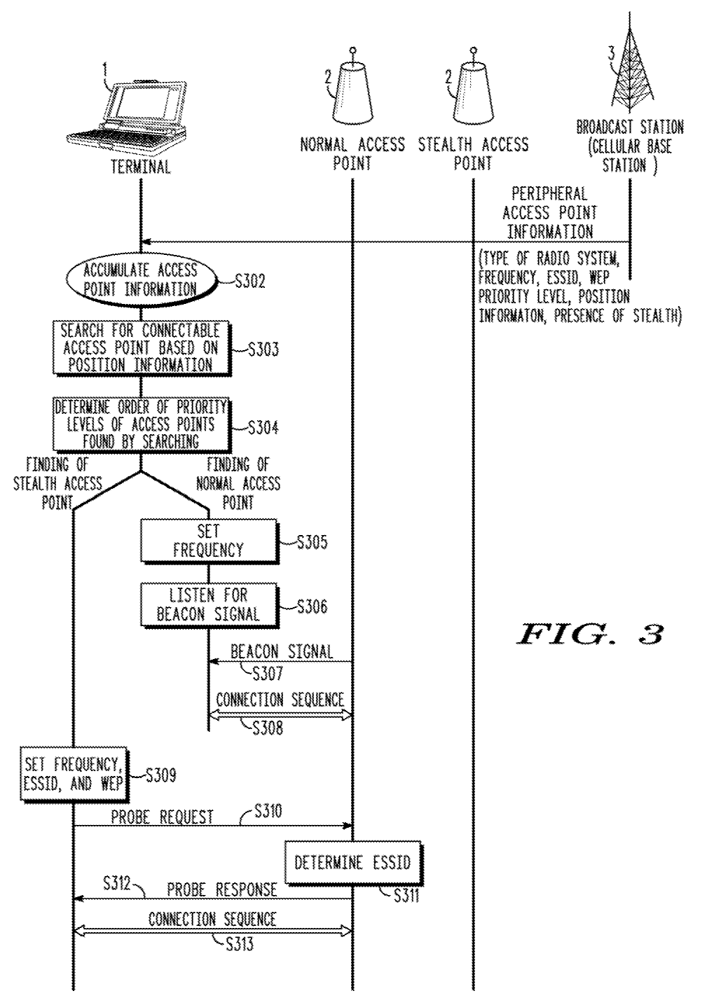

FIG. 3 is a sequence diagram according to the present invention.

(S301) The broadcast station (or cellar base station) 3 is broadcasting peripheral access point information of neighbor access points. Such peripheral access point information contains, among others, “presence or absence of stealth”, “spot coverage information”, and “priority level”.

(S302) The terminal 1 accumulates the peripheral access point information received from the broadcast station 3.

(S303) The terminal 1 searches for an access point to which the terminal in the current position can connect based on the “spot coverage information” of the access point information.

(S304) The terminal 1 determines the order of “priority levels” of the access points found by searching.

(S305) In the case of finding a normal access point, a frequency used by the normal access point is set.

(S306) Then, the terminal 1 listens for a beacon signal sent from the normal access point 2 for a certain period of time.

(S307) The normal access point 2 sends a beacon signal containing an ESSID at regular intervals. The terminal 1 receives such a beacon signal.

(S308) Upon receiving the beacon signal, the terminal 1 processes a connection sequence with respect to the normal access point 2.

(S309) In the case of finding a stealth access point, a frequency used by the stealth access point is set, and an ESSID and a WEP are identified.

(S310) The terminal 1 sends a probe request containing the ESSID to the stealth access point 2.

(S311) The stealth access point 2 determines whether or not the ESSID contained in the probe request matches with its own ESSID.

(S312) If they match, the stealth access point 2 sends a probe response back to the terminal 1.

(S313) Upon receiving the probe request, the terminal 1 processes a connection sequence with respect to the stealth access point 2.

As described above, according to the terminal, program, and access point finding method regarding the present invention, a probe request is not required to send to all of registered ESSIDs to find a stealth access point. Therefore, a terminal can reduce the number of transmissions of probe requests for finding a stealth access point, and radio resources of a network as well as power consumption of the terminal can be reduced.

In the foregoing various embodiments of the present invention, various alterations, modifications, and omissions may be readily made by those skilled in the art without departing from the spirit and scope of the present invention. The foregoing description is only illustrative and is not intended to limit the present invention. The present invention is limited only by the appended claims and equivalents thereof.

What is claimed is:

1. A terminal for communication with a normal access point that reports a network identifier, and a stealth access point that does not report a network identifier, comprising:
access point information accumulating means for accumulating access point information that indicates whether each access point is a normal access point or a stealth access point;
beacon signal detecting means for listening for and detecting a beacon signal containing a network identifier;
probe request sending means for sending a probe request containing a network identifier; and
access point finding control means for controlling the beacon signal detecting means to detect the beacon signal with respect to the normal access point, and controlling the probe request sending means to send the probe request with respect to the stealth access point.

2. The terminal according to claim 1, further comprising:
position measuring means for measuring a current position,
wherein the access point information accumulating means contains spot coverage information in access point information of each access point, and
wherein the access point finding control means controls the probe request sending means to send a probe request only to a stealth access point the spot coverage information of which includes the current position of the relevant terminal.

3. The terminal according to claim 2, wherein the probe request sending means includes means for sending a plurality of probe requests sequentially at a time interval that is shorter than a transmission interval of a normal probe request.

4. A terminal according to claim 2 wherein beacon signal detecting means includes means for receiving access point information from a broadcast station.

5. The terminal according to claim 1, wherein the probe request sending means includes means for sending a plurality of probe requests sequentially at a time interval that is shorter than a transmission interval of a normal probe request.

6. A terminal according to claim 5 wherein beacon signal detecting means includes means for receiving access point information from a broadcast station.

7. A terminal according to claim 1 wherein beacon signal detecting means includes means for receiving access point information from a broadcast station.

8. A method of finding an access point in a device that can communicate with a normal access point that reports a network identifier and a stealth access point that does not report a network identifier, the method comprising:
accumulating access point information that indicates whether each access point is a normal access point or a stealth access point in an access point information accumulating section;
listening for and detecting a beacon signal containing a network identifier with respect to the normal access point; and
sending a probe request containing a network identifier with respect to the stealth access point.

9. A method of finding an access point as defined in claim 8,
wherein the access point information accumulating section contains spot coverage information in access point information of each access point, and
wherein sending the probe request comprises sending a probe request only to a stealth access point for which the device is within the coverage area based upon information in the access point information section of the device.

10. A method of finding an access point as defined in claim 9, wherein sending the probe request comprises sending a plurality of probe requests sequentially at a time interval that is shorter than a transmission interval of a normal probe request.

11. A method of finding an access point as defined in claim 8, wherein sending the probe request comprises sending a plurality of probe requests sequentially at a time interval that is shorter than a transmission interval of a normal probe request.
